(19) United States
(12) Patent Application Publication
(10) Pub. No.: US 2020/0198548 A1
(43) Pub. Date: Jun. 25, 2020

(54) MOVABLE BODY

(71) Applicant: HONDA MOTOR CO., LTD., Tokyo (JP)

(72) Inventor: Shintaro OHTAKI, Wako-shi (JP)

(21) Appl. No.: 16/690,377

(22) Filed: Nov. 21, 2019

(30) Foreign Application Priority Data
Dec. 21, 2018 (JP) 2018-239998

(51) Int. Cl. B60R 11/04; B60S 1/54; B60H 1/00

(52) U.S. Cl. CPC B60R 11/04; B60R 2011/0026; B60H 1/00785; B60S 1/54

(57) ABSTRACT

A movable body comprising a monitoring device configured to monitor a surrounding environment of the movable body through a window member, a heating device configured to heat a portion of the window member within a monitoring area of the monitoring device, an air conditioning device, and a control device, wherein operation modes of the air conditioning device include an internal air circulation mode and an external air introduction mode, and if the heating device is to be driven when the operation mode of the air conditioning device is the internal air circulation mode, the control device changes the operation mode to the external air introduction mode.

### CROSS-REFERENCE TO RELATED APPLICATION(S)

This application claims priority to and the benefit of Japanese Patent Application No. 2018-239998 filed on Dec. 21, 2018 the entire disclosure of which is incorporated herein by reference.

### BACKGROUND OF THE INVENTION

### Field of the Invention

The present invention particularly relates to a movable body that is provided with a monitoring device.

### Description of the Related Art

Some vehicles are provided with a camera inside the vehicles, which serves as a monitoring device that can monitor the surrounding environment (see Japanese Patent Laid-Open No. 2017-206098). Such a camera is provided on the side of the inner wall of the windshield, and makes it possible to monitor the outside of the vehicle through the windshield. Japanese Patent Laid-Open No. 2017-206098 discloses that a heater that is constituted by an electric heating wire is provided as a heating device together with a camera, in order to remove fog on the windshield, such as condensation, frost, or ice.

The above-described configuration is desired to be further improved in terms of controllability, in order to effectively remove fog (fog removal) or prevent fog from being generated (fog prevention). The same applies not only to terrestrial vehicles, but also to ships, for example.

### SUMMARY OF THE INVENTION

The present invention makes it possible to effectively and relatively easily realize fog removal and fog prevention.

One of the aspects of the present invention provides a movable body comprising a monitoring device configured to monitor a surrounding environment of the movable body through a window member that is light-transmissive and defines the inside and the outside of the movable body, a heating device configured to heat a portion of the window member within a monitoring area of the monitoring device, an air conditioning device configured to perform air conditioning in the movable body, and a control device configured to perform drive control on the heating device and the air conditioning device, wherein operation modes of the air conditioning device include an internal air circulation mode in which the air conditioning is performed by circulating the air in the movable body, and an external air introduction mode in which the air conditioning is performed by taking the air outside the movable body into the movable body, and if the heating device is to be driven when the operation mode of the air conditioning device is the internal air circulation mode, the control device changes the operation mode to the external air introduction mode.

Further features of the present invention will become apparent from the following description of exemplary embodiments with reference to the attached drawings.

### BRIEF DESCRIPTION OF THE DRAWINGS

FIG. 1 is a schematic diagram illustrating an example of a configuration of a vehicle according to an embodiment.

FIG. 2A is a schematic diagram illustrating an example of a configuration of an on-board electronic component.

FIG. 2B is a schematic diagram illustrating an example of a configuration of an on-board electronic component.

FIG. 3 is a block diagram illustrating an example of a configuration of a portion of a vehicle.

FIG. 4 is a flowchart illustrating an example of the content of control that is performed by a control device.

FIG. 5A is a diagram illustrating an example of drive control that is performed on a heating device and an air conditioning device.

FIG. 5B is a diagram illustrating an example of drive control that is performed on a heating device and an air conditioning device.

### DESCRIPTION OF THE EMBODIMENTS

The following describes an embodiment of the present invention with reference to the accompanying drawings. Note that each of the drawings is a schematic diagram showing a structure or a configuration of the embodiment, and each of the members in the drawings is not necessarily drawn to scale. Also, in each of the drawings, the same members or the same constituent elements are assigned the same reference numerals, and descriptions of duplicate contents are omitted.

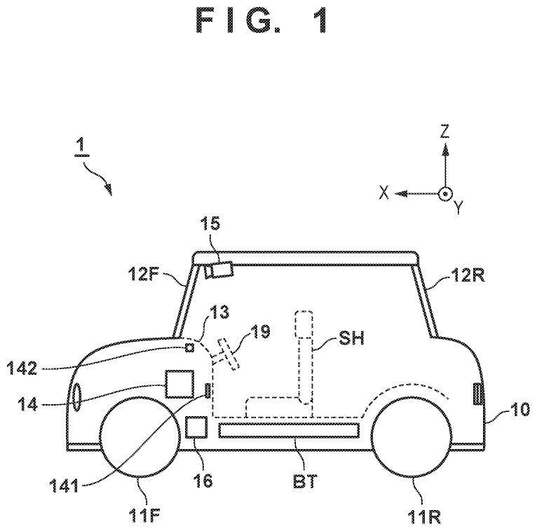

FIG. 1 is a schematic diagram showing a vehicle 1 according to an embodiment. In order to facilitate understanding of a structure, an X axis, a Y axis, and a Z axis that are orthogonal to each other are shown in the drawings (the same applies to the other drawings described below). The X direction corresponds to the longitudinal direction of the vehicle body, the Y direction corresponds to the left-right direction of the vehicle body, or the vehicle width direction, and the Z direction corresponds to the height direction of the vehicle body. In the present description, expressions such as front/rear, left/right (side), top/bottom, and inside/outside of the vehicle body (vehicle interior/exterior) indicate a positional relationship relative to a vehicle body 10.

The vehicle 1 is a four-wheeled vehicle that is provided with a pair of left and right front wheels 11F and a pair of left and right rear wheels 11R, but the number of wheels is not limited to four. Also, the vehicle 1 is an electric vehicle that is provided with a battery BT, but may be additionally provided with an internal-combustion engine. A secondary battery such as a lithium ion battery is used as the battery BT, and the battery BT stores electric power that is to be supplied to elements corresponding thereto in the vehicle 1.

The vehicle 1 also includes window members 12F and 12R that define the inside and the outside of the vehicle. The window members 12F and 12R may be constituted by a light-transmissive material (such as glass or resin). In the drawing, the window member 12F is shown as a windshield, a front window, or a front glass, and the window member 12R is shown as a rear window or a rear glass. However, other window members such as a side window or a side glass may also be provided. In this example, a seat SH is shown in the cabin as a driver's seat in order to simplify the drawing. However, other seats may be additionally provided in the cabin.

An operation unit 19 that is used by a user (in particular, a driver) to input a predetermined operation is provided in a cabin front structure 13 that includes a dashboard panel and so on. In the drawing, a steering wheel is shown as a typical example of the operation unit 19. However, the concept of operation that is to be input to the operation unit 19 includes, in addition to a driving operation, related operations that directly/indirectly accompany the driving operation. An example of the related operations is an air conditioning management operation in the cabin.

In addition, as shown in FIG. 1, the vehicle 1 also includes an air conditioning device 14, an electronic component 15, and a control device 16. A well-known configuration may be applied to the air conditioning device 14. For example, the air conditioning device 14 includes an evaporator, a compressor, a condenser, a pipe that connects them and provides a refrigerant flow path, various valves that are provided on the flow path, and so on. The air conditioning device 14 also includes a blower fan that generates a predetermined airflow as conditioned air, a fan motor that drives the blower fan, a heater core that heats the conditioned air, and so on.

The air conditioning device 14 also includes an air conditioner duct 141, a defroster duct 142, and a door mechanism (e.g. a plate door or a rotary door) for switching between them to send out the conditioned air from one of them. The defroster duct 142 is an outlet via which conditioned air is sent out toward the window member 12F/conditioned air is blown against the window member 12F, and a main objective thereof is to perform fog removal/fog prevention on the window member 12F. The air conditioner duct 141 in this example is an outlet other than the above-described defroster duct 142, and a main objective thereof is to perform air conditioning management in the cabin. Therefore, it can be expressed that the air conditioning device 14 includes a cabin blower for sending out air from the air conditioner duct 141, and a fog removal/fog prevention blower (a defroster device) for sending out air from the defroster duct 142. Although the drawing shows a single air conditioner duct 141 that is provided in the cabin front structure 13, a plurality of air conditioner ducts 141 are typically provided so as to be able to send out conditioned air to the user or the surroundings of the user (e.g. rearward or rearward and downward).

The user can activate/deactivate the air conditioning device 14 by inputting an operation to the operation unit 19. Operation modes of the air conditioning device 14 in an active state include an internal air circulation mode and an external air introduction mode, the details of which will be described later. The user can select one of the ducts 141 and 142 in the air conditioning device 14 in an active state, from which conditioned air is to be sent out, by inputting an operation to the operation unit 19. For example, the user can input a predetermined operation to the operation unit 19 so that conditioned air is sent out from one or both of the ducts 141 and 142.

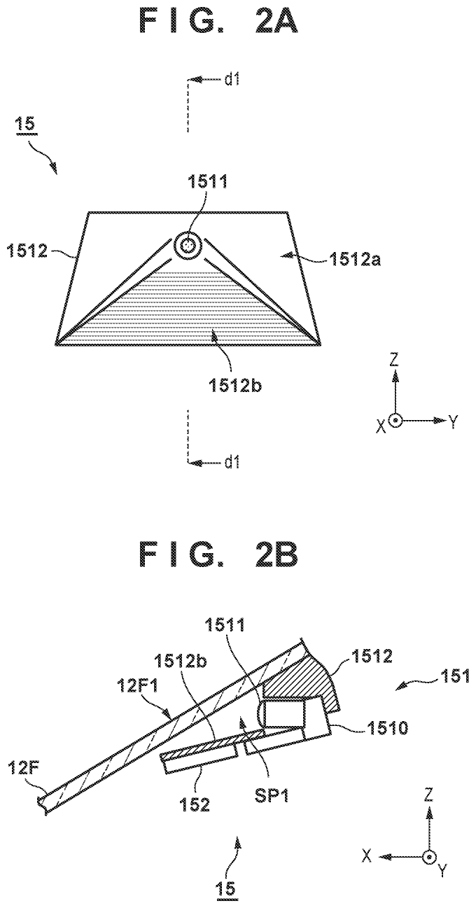

FIG. 2A is a front view showing a configuration of the electronic component 15. FIG. 2B is a cross-sectional view of the electronic component 15 taken along a cutting line di-di in FIG. 2A. The electronic component 15 includes a monitoring device 151 that can monitor the surrounding environment of the self-vehicle through the window member 12F and a heating device 152 that can heat the window member 12F, and the electronic component 15 is provided in the vicinity of the inner wall (the surface inside the vehicle) of the window member 12F.

A camera that can capture an image of the above-described surrounding environment can be used as the monitoring device 151. In the present embodiment, the monitoring device 151 includes a device body 1510, a detector 1511, and a base member 1512. A well-known imaging sensor such as a CCD/CMOS image sensor is used as the detector 1511, and the detector 1511 makes it possible to detect or capture an image of the above-described surrounding environment (in the present embodiment, the environment in front of the vehicle 1). A processor that processes the result of detection performed by the detector 1511 is built into the device body 1510, and the result of processing performed by the processor is output to the control device 16 described below as image data.

The base member 1512 is a bracket for fixing the above-described device body 1510 and detector 1511 to the vehicle body 10, and fixing the heating device 152 described below. The base member 1512 includes an abutting portion 1512a and a recessed portion 1512b. The abutting portion 1512a abuts against the inner wall of the window member 12F, and is fixed to the window member 12F using an adhesive, for example.

The recessed portion 1512b is recessed in the abutting portion 1512a, and has a substantially triangular or trapezoidal shape in a top view or a front view thereof. An opening is provided at the rear end of the recessed portion 1512b, through which the detection surface of the detector 1511 is exposed to the outside. That is to say, the recessed portion 1512b of the base member 1512 faces the inner wall of the window member 12F, a space SP1 is formed between the base member 1512 and the window member 12F. The detection surface of the detector 1511 is located in the space SP1. As can be seen from FIG. 2B, the space SP1 is formed so as to narrow in a direction from the rear side to the front side in side view.

With such a configuration, the monitoring device 151 can monitor the surrounding environment (in the present embodiment, the environment in front of the vehicle 1) through the window member 12F. Note that surface treatment may be applied to the upper surface of the recessed portion 1512b in order to prevent light reflection.

A portion of the window member 12F located in the monitoring area (and the neighboring area thereof) of the monitoring device 151 is referred to as a portion 12F1. In the present embodiment, the portion 12F1 corresponds to a portion that is forward of, and upward of, the above-described space SP1. Here, as described above, an opening, through which the detection surface of the detector 1511 is exposed to the outside, is provided in a rear portion of the recessed portion 1512b. Also, as can be seen from FIG. 2B, a gap (approximately 0.1 cm to approximately 1.0 cm) is formed between the front end of the recessed portion 1512b and the window member 12F. Therefore, the above-described space SP1 is substantially not sealed, and is in communication with the inside of the vehicle.

However, the space SP1 is surrounded by the window member 12F and the base member 1512, and therefore, in such a space SP1, a gas (air) is likely to stop flowing, and fog may be likely to be generated on the above-described portion 12F1, depending on the environment (in particular, the temperature and the humidity in the vehicle 1). Typically, such fog is generated as a result of water droplets or the like adhering to the portion 12F1 when the humidity in the cabin is relatively high and the temperature of the window member 12F is relatively low.

The heating device 152 is provided on the recessed portion 1512b of the base member 1512, and heats the above-described portion 12F1 via the gas (air) in the space SP1. Additionally, when the air conditioning device 14 is in an active state, a gas that flows into the space SP1 through the gap between the front end of the recessed portion 1512b and the window member 12F is heated by the heating device 152, and thus heats the above-described portion 12F1. In this way, the heating device 152 removes fog on the above-described portion 12F1, and/or prevents fog from being generated on the above-described portion 12F1 (this may be simply referred to as “fog removal/prevention” in the present description). The heating device 152 need only be configured to be able to generate a desired amount of heat. In the present embodiment, an electric heating wire that is built into the recessed portion 1512b, and a heater driver that energize the electric heating wire to generate heat, are used. The heater driver supplies the electric heating wire with a current that is based on electric power from the battery BT.

The control device 16 in the present embodiment is an ECU (electronic control unit) that includes a CPU (central processing unit), a memory, and an external communication interface, and performs drive control on each element of the vehicle 1 based on a predetermined program. In another embodiment, a semiconductor device such as a PLD (programmable logic device) or an ASIC (application specific integrated circuit) may be used as the control device 16. That is to say, the functions of the control device 16 described in the present description can be realized by either hardware or software.

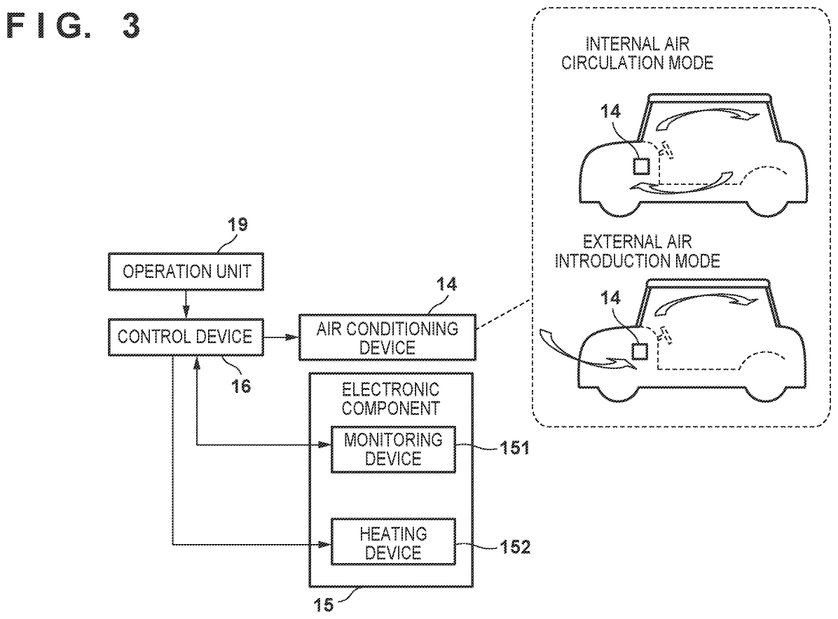

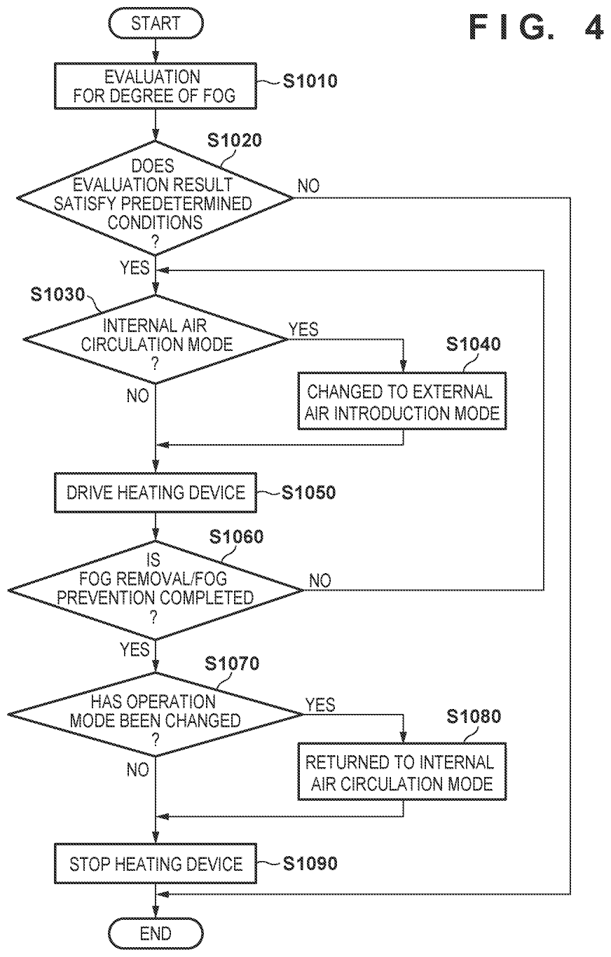

FIG. 3 is a block diagram showing a portion of the system configuration of the vehicle 1. The control device 16 transmits/receives signals to/from several elements included in the vehicle 1, and performs drive control on the elements based on an operation input by the user to the operation unit 19, for example.

For example, the control device 16 performs drive control on the air conditioning device 14. Operation modes of the air conditioning device 14 include an internal air circulation mode and an external air introduction mode. As shown in FIG. 3, in the internal air circulation mode, the air conditioning device 14 circulates the air inside the vehicle to perform air conditioning, and in the external air introduction mode, the air conditioning device 14 takes the air outside the vehicle into the vehicle to perform air conditioning. Switching between these operation modes can be realized by additionally providing a switching door that selectively introduces the air inside the vehicle or the air outside the vehicle to the blower fan, as a part of the air conditioning device 14. Here, in order to simplify this description, two operation modes, namely the internal air circulation mode and the external air introduction mode, are illustrated. However, in another embodiment, the air conditioning device 14 may also have an intermediate operation mode between the internal air circulation mode and the external air introduction mode.

Also, the control device 16 receives information (image data in the present embodiment) indicating the above-described surrounding environment from the monitoring device 151, and performs predetermined driving assistance based on the information. Driving assistance mentioned above is a concept that includes not only the provision of necessary/useful information for driving to the driver, but also so-called automated driving, i.e. at least one of the drive operations (typically, acceleration, braking, and steering) is performed by the control device 16, not by the driver.

Also, the control device 16 performs drive control on the heating device 152. The heating device 152 is driven by the control device 16 upon predetermined conditions being satisfied. However, the heating device 152 may be additionally driven based on an operation input by the user to the operation unit 19.

To simplify this description, the control device 16 is illustrated as a single unit in FIG. 3. However, in many cases, the control device 16 is constituted by a plurality of ECUs that are provided so as to be able to communicate with each other, and the plurality of ECUs may be provided at their respective positions in the vehicle body 10. Also, each ECU may be constituted by one or more electrical components mounted on a mounting board.

FIG. 4 is a flowchart showing an example of the content of control that is performed by the control device 16. In short, in this flowchart, the heating device 152 is driven based on the result of evaluation regarding the degree of fog on the window member 12F, and if the operation mode of the air conditioning device 14 is the internal air circulation mode at that time, the operation mode is switched to the external air introduction mode. These operations are mainly performed by the CPU in the control device 16, executing a predetermined program.

In step S1010 (hereinafter simply referred to as “S1010”. The same applies to the other steps.), the degree of fog on the portion 12F1 of the window member 12F is evaluated. This evaluation includes not only an evaluation of the degree of actual fog present at the time of the evaluation (whether or not fog is actually present), but also an evaluation or prediction of the degree of fog in the relatively near future (whether or not there will be fog in the relatively near future). These evaluations may be realized using a well-known method. For example, the degree of actual fog can be evaluated by performing a predetermined image analysis on image data that is the result of monitoring performed by the monitoring device 151. Also, the degree of fog in the relatively near future can be evaluated based on the temperature outside the vehicle and/or the humidity in the vehicle.

In S1020, whether or not the result of evaluation in S1010 satisfies predetermined conditions is determined. If it has been determined that there is the possibility that fog is actually present/fog may be present in the relatively near future based on the result of evaluation in S1010, processing proceeds to S1030. On the other hand, if it has not been determined that fog is actually present/fog may be present in the relatively near future, the flowchart is terminated.

In S1030, whether or not the air conditioning device 14 is in the internal air circulation mode is determined. If the air conditioning device 14 is in the internal air circulation mode, processing proceeds to S1040 and the operation mode of the air conditioning device 14 is changed to the external air introduction mode in S1040. Thereafter, processing proceeds to S1050. On the other hand, if the operation mode is not the internal air circulation mode (if the operation mode is already the external air introduction mode), processing proceeds to S1050 without change.

In S1050, the heating device 152 is driven. As a result, the space SP1 is heated, the portion 12F1 of the window member 12F is accordingly heated, and thus fog removal/fog prevention is performed.

In S1060, whether or not fog removal/fog prevention has been completed is determined. This determination may be performed using the same method as in the above-described S1010, for example, or performed based on the time elapsed after the driving of the heating device 152 has been started. The elapsed time may be a constant value, or a variable value that is based on the temperature outside the vehicle/the humidity in the vehicle. If fog removal/fog prevention has been completed, processing proceeds to S1070, and otherwise processing returns to S1030.

In S1070, whether or not the operation mode of the air conditioning device 14 has been changed in S1030 to S1040 is determined. If the operation mode has been changed, processing proceeds to S1080, and the operation mode of the air conditioning device 14 is returned to internal air circulation mode in S1080. Thereafter, processing proceeds to S1090. On the other hand, if the operation mode has not been changed, processing proceeds to S1090 without change.

In S1090, the heating device 152 is stopped (is restricted from driving), and the flowchart is terminated. Generally, the window member 12F may include a heat-insulating layer as an intermediate layer, and therefore, once the inner wall of the window member 12F has been heated, the above-described fog is unlikely to be generated. Therefore, S1080 (returning the operation mode to the internal air circulation mode) and S1090 (stopping the heating device 152) may be performed immediately after fog removal/fog prevention has been completed.

On the other hand, in another embodiment, S1090 may be omitted after fog removal/fog prevention has been completed (the heating device 152 may be kept in a driving state). As a result, the effect of fog prevention by the heating device 152 continues.

Note that the above-described flowchart may be partially modified so as not to depart from the spirit thereof. For example, another step may be added, or the order of the steps may be changed.

According to the above-described control, even if the operation mode of the air conditioning device 14 is the internal air circulation mode, the operation mode is changed to the external air introduction mode when the heating device 152 is to be driven, and the air outside the vehicle with relatively low humidity is taken into the vehicle. As a result, the air taken from the outside of the vehicle is sent out to the cabin as conditioned air, and some of the conditioned air flows into the above-described space SP1. Through such control, it is possible to effectively and relatively easily perform fog removal/fog prevention on the window member 12F, and the monitoring device 151 can appropriately monitor the surrounding environment. After fog removal/fog prevention has been completed, the operation mode of the air conditioning device 14 is returned to the internal air circulation mode (S1080). Thus, it is possible to perform air conditioning without causing the user discomfort.

Also, in the present embodiment, the heating device 152 is driven based on electric power from the battery BT. Therefore, according to the above-described control, it is possible to reduce the power consumption of the battery BT by avoiding unnecessarily driving the heating device 152 or shortening the driving time of the heating device 152.

As described above, the operation modes of the air conditioning device 14 may also include an intermediate mode between the internal air circulation mode and the external air introduction mode. In such a case, in S1030, whether or not the operation mode of the air conditioning device 14 is closer to the internal air circulation mode relative to a criterion may be determined. Then, in S1040, the operation mode may be changed such that the proportion of external air introduction after the change is greater than that before the change, i.e. such that the operation mode after the change is closer to the external air introduction mode than the operation mode before the change is.

Here, regarding the air conditioning device 14, the user can select one of the ducts 141 and 142, from which conditioned air is to be sent out, by inputting an operation to the operation unit 19, as described above. Generally, conditioned air from the defroster duct 142 is effective for achieving the above-described fog removal/fog prevention. On the other hand, conditioned air from the defroster duct 142 may cause the occupant discomfort. Therefore, in addition to the above-described S1040 (an operation mode change), how one of the ducts 141 and 142, from which conditioned air is to be sent out, is selected may be taken into consideration.

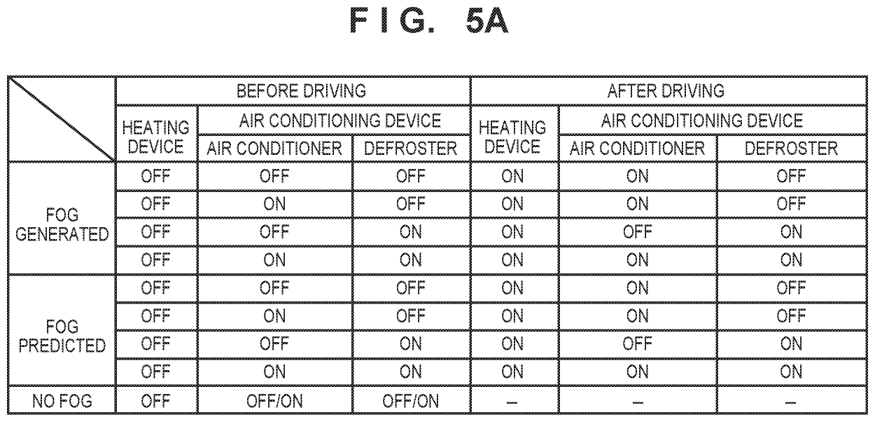

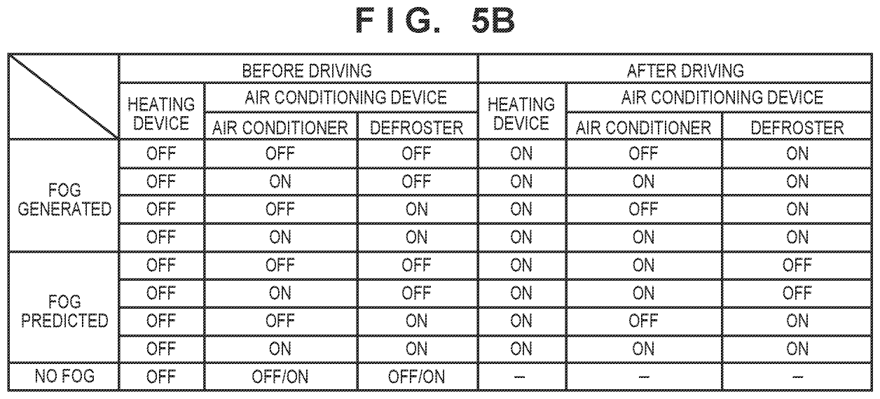

FIG. 5A is a table showing an example of the content of drive control that is performed on the heating device 152 and the air conditioning device 14. In the drawing, the state of the air conditioning device 14 before/after the heating device 152 has been driven is shown for each of the following items: “fog generated (the case in which fog has been actually generated)”; “fog predicted (the case in which there is the possibility of fog being generated in the relatively near future); and “no fog (the case in which fog has not been generated or predicted”. Also, in the drawing, “air conditioner ON” indicates that air is sent out from the air conditioner duct 141, and “air conditioner OFF” indicates that air is restricted from being sent out from the air conditioner duct 141. Similarly, “defroster ON” indicates a state in which air is sent out from the defroster duct 142, and “defroster OFF” indicates that air is restricted from being sent out from the defroster duct 142.

For example, regarding the item “fog generated”, it is shown that, if the air conditioner is OFF and the defroster is OFF before the heating device 152 has been driven, the air conditioner is to be ON and the defroster is to be OFF after the heating device 152 has been driven. This shows that, if the air conditioning device 14 is in an inactive state (the air conditioner is OFF and the defroster is OFF) when it is determined in S1010 that fog is actually present, an operation state in which the air conditioner is ON and the defroster is OFF is realized in the external air introduction mode.

If the air conditioner is ON and the defroster is OFF before the heating device 152 has been driven, fog removal is performed in the external air introduction mode in which the air conditioner is ON and the defroster is OFF, after the heating device 152 has been driven. On the other hand, if the air conditioner is OFF and the defroster is ON before the heating device 152 has been driven, fog removal is performed in the external air introduction mode in which the air conditioner is OFF and the defroster is ON, after the heating device 152 has been driven. If the air conditioner is ON and the defroster is OFF before the heating device 152 has been driven, fog removal is performed in the external air introduction mode, in which the air conditioner is ON and the defroster is ON, after the heating device 152 has been driven.

The same applies to the item “fog predicted”. That is to say, if the air conditioner is OFF and the defroster is OFF before the heating device 152 has been driven, fog prevention is performed in the external air introduction mode in which the air conditioner is ON and the defroster is OFF, after the heating device 152 has been driven. If the air conditioner is ON and the defroster is OFF before the heating device 152 has been driven, fog prevention is performed in the external air introduction mode in which the air conditioner is ON and the defroster is OFF, after the heating device 152 has been driven. If the air conditioner is OFF and the defroster is ON before the heating device 152 has been driven, fog prevention is performed in the external air introduction mode in which the air conditioner is OFF and the defroster is ON, after the heating device 152 has been driven. If the air conditioner is ON and the defroster is ON before the heating device 152 has been driven, fog prevention is performed in the external air introduction mode in which the air conditioner is ON and the defroster is ON, after the heating device 152 has been driven.

That is to say, in the example shown in FIG. 5A, if the user allows the defroster to be ON or if the user is using air conditioning through the defroster duct 142 before the heating device 152 has been driven, fog removal/fog prevention is performed by sending out conditioned air from the defroster duct 142 in the external air introduction mode. On the other hand, if the user does not allow the defroster to be ON or if the user is not using air conditioning through the defroster duct 142 before the heating device 152 has been driven, fog removal/fog prevention is performed by sending out conditioned air from the air conditioner duct 141 in the external air introduction mode. With such control, it is possible to perform fog removal while reducing discomfort that may be given to the occupant by air from the defroster duct 142. Note that, regarding “no fog”, which is also shown in the drawing, there is no need to perform fog removal/fog prevention, and therefore the heating device 152 is not to be driven.

FIG. 5B shows another example of the content of drive control that is performed on the heating device 152 and the air conditioning device 14, as in FIG. 5A. The example shown in FIG. 5B is different from the example shown in FIG. 5A in that, regarding the item “fog generated”, if the air conditioner is ON or OFF and the defroster is OFF before the heating device 152 has been driven, the defroster is to be ON after the heating device 152 has been driven. That is to say, if fog has been actually generated, such fog is desired to be immediately removed, and even if the defroster is OFF before the heating device 152 has been driven, the defroster is turned ON. In contrast, regarding the item “fog predicted”, even though there is the possibility of fog being generated in the relatively near future, the same control as in the example shown in FIG. 5A is employed because fog has not been actually generated.

That is to say, in the example shown in FIG. 5B, if fog has been actually generated, conditioned air is sent out from the defroster duct 142 in the external air introduction mode so that fog can be immediately removed. On the other hand, if fog has not been generated, conditioned air is sent out from the air conditioner duct 141 in the external air introduction mode, and thus fog prevention is performed. With such control, it is possible to perform fog removal/fog prevention while reducing discomfort that may be caused to the occupant.

Although two examples shown in FIGS. 5A and 5B are described here, various modifications may be applied thereto within the scope of the spirit thereof. For example, as described above, a plurality of air conditioner ducts 141 are typically provided, and therefore, one of them from which conditioned air is to be sent out may be selected based on more detailed conditions.

As described above, according to the present embodiment, if the heating device 152 is to be driven when the operation mode of the air conditioning device 14 is the internal air circulation mode, the control device 16 changes the operation mode to the external air introduction mode. That is to say, even if the operation mode of the air conditioning device 14 is the internal air circulation mode, the operation mode is changed to the external air introduction mode when the heating device 152 is driven, and the air outside the vehicle with a relatively low humidity is taken into the vehicle. As a result, it is possible to effectively and relatively easily perform fog removal/fog prevention on the window member 12F and enable the monitoring device 151 to appropriately monitor the surrounding environment, and to avoid unnecessarily driving the heating device 152 and reduce power consumption.

In the embodiment, a camera is given as a preferable example of the monitoring device 151. However, the content of the embodiment is also applicable to other devices that are provided with a monitoring function. For example, fog on the window member 12F (such as water droplets adhering to the inner wall) changes the refraction index, which may cause a change in the monitoring area of the monitoring device 151. Therefore, the monitoring device 151 may be a radar (millimeter wave radar) or a LiDAR (Light Detection and Ranging). Also, the monitoring device 151 may be configured to monitor an area on the rear side or lateral side of the vehicle 1. For example, the content of the embodiment is also applicable to fog removal/fog prevention that is performed on the window member 12R.

Although some preferable embodiments have been described above, the present invention is not limited to them, and may be partially modified within the scope of the spirit of the present invention. For example, a part of one embodiment may be combined with another embodiment according to the purpose and so on. Also, the terms that indicate the elements in the present description are only used to illustrate the present invention. The present invention is not limited to the exact meanings of the terms, and includes equivalents thereof as well. For example, although the present description shows the vehicle 1 as a typical example, the content of each embodiment is applicable to vehicles that are not provided with wheels (e.g. ships), i.e. to various movable bodies.

Some features of the above-described embodiments can be summarized as follows:

A first aspect pertains to a movable body (e.g. 1), the movable body including: a monitoring device (e.g. 151) configured to monitor a surrounding environment of the movable body through a window member (e.g. 12F) that is light-transmissive and defines the inside and the outside of the movable body; a heating device (e.g. 152) configured to heat a portion (e.g. 12F1) of the window member within a monitoring area of the monitoring device; an air conditioning device (e.g. 14) configured to perform air conditioning in the movable body; and a control device (e.g. 16) configured to perform drive control on the heating device and the air conditioning device. Operation modes of the air conditioning device include: an internal air circulation mode in which the air conditioning is performed by circulating the air in the movable body; and an external air introduction mode in which the air conditioning is performed by taking the air outside the movable body into the movable body (see FIG. 3). If the heating device is to be driven when the operation mode of the air conditioning device is the internal air circulation mode, the control device changes the operation mode to the external air introduction mode.

With this configuration, it is possible to effectively and relatively easily perform fog removal/fog prevention on the window member. Additionally, the monitoring device is enabled to appropriately monitor the surrounding environment, and the heating device is prevented from unnecessarily driving.

According to a second aspect, the monitoring device includes: a detector (e.g. 1511) configured to detect the surrounding environment; and a base member (e.g. 1512, 1512b) that faces an inner wall of the window member, and is disposed such that a detection surface of the detector is located within a space (e.g. SP1) between the base member and the window member, and the space is in communication with a space in the movable body.

With this configuration, it is possible to let conditioned air with a relatively low humidity to flow into the above-described space, and appropriately realize the above-described fog removal/fog prevention.

According to a third aspect, the control device evaluates the degree of fog on the portion of the window member (e.g. S1010), and drives the heating device based on the result of evaluation (e.g. S1050).

With this configuration, it is possible to appropriately realize the above-described fog removal/fog prevention.

According to a fourth aspect, the control device performs the evaluation based on the result of monitoring received from the monitoring device.

With this configuration, it is possible to directly evaluate the degree of actual fog.

According to a fifth embodiment, the control device performs the evaluation based on the temperature outside the movable body.

With this configuration, it is possible to evaluate not only the degree of actual fog, but also the degree of fog that may be generated in the relatively near future.

According to a sixth embodiment, the control device performs the evaluation based on the humidity in the movable body.

With this configuration, it is possible to evaluate not only the degree of actual fog, but also the degree of fog that may be generated in the relatively near future.

According to a seventh aspect, if a predetermined condition is satisfied after the operation mode has been changed from the internal air circulation mode to the external air introduction mode, the control device returns the operation mode to the internal air circulation mode (e.g. S1080).

By returning the operation mode to the internal air circulation mode after the above-described fog removal/fog prevention has been completed, it is possible to perform air conditioning without causing the user discomfort.

According to an eighth aspect, when returning the operation mode to the internal air circulation mode, the control device keeps the heating device in a driving state.

With this configuration, it is possible to continue fog prevention.

According to a ninth aspect, a defroster duct (e.g. 142) is provided in the movable body as a part of the air conditioning device, and when changing the operation mode to the external air introduction mode, the control device sends out air from the defroster duct.

With this configuration, it is possible to more appropriately realize the above-described fog removal/fog prevention.

According to a tenth aspect, the monitoring device is a camera (e.g. 1511) for monitoring an environment in front of the movable body, and the window member is a windshield (e.g. 12F).

That is to say, each of the above-described aspects is desirably applicable to a movable body (typically a vehicle) that is provided with a driving assistance function.

According to an eleventh aspect, the movable body is an electric vehicle (e.g. 1).

With this configuration, it is possible to avoid unnecessarily driving the heating device, and reduce battery power consumption.

What is claimed is:

1. A movable body comprising:
a monitoring device configured to monitor a surrounding environment of the movable body through a window member that is light-transmissive and defines the inside and the outside of the movable body;
a heating device configured to heat a portion of the window member within a monitoring area of the monitoring device;
an air conditioning device configured to perform air conditioning in the movable body; and
a control device configured to perform drive control on the heating device and the air conditioning device,
wherein operation modes of the air conditioning device include:
an internal air circulation mode in which the air conditioning is performed by circulating the air in the movable body; and
an external air introduction mode in which the air conditioning is performed by taking the air outside the movable body into the movable body, and
if the heating device is to be driven when the operation mode of the air conditioning device is the internal air circulation mode, the control device changes the operation mode to the external air introduction mode.

2. The movable body according to claim 1,
wherein the monitoring device includes:
a detector configured to detect the surrounding environment; and
a base member that faces an inner wall of the window member, and is disposed such that a detection surface of the detector is located within a space between the base member and the window member, and
the space is in communication with a space in the movable body.

3. The movable body according to claim 1,
wherein the control device evaluates the degree of fog on the portion of the window member, and drives the heating device based on the result of evaluation.

4. The movable body according to claim 3,
wherein the control device performs the evaluation based on the result of monitoring received from the monitoring device.

5. The movable body according to claim 3,
wherein the control device performs the evaluation based on the temperature outside the movable body.

6. The movable body according to claim 3,
wherein the control device performs the evaluation based on the humidity in the movable body.

7. The movable body according to claim 1,
wherein, if a predetermined condition is satisfied after the operation mode has been changed from the internal air circulation mode to the external air introduction mode, the control device returns the operation mode to the internal air circulation mode.

8. The movable body according to claim 7,
wherein, when returning the operation mode to the internal air circulation mode, the control device keeps the heating device in a driving state.

9. The movable body according to claim 1,
wherein a defroster duct is provided in the movable body as a part of the air conditioning device, and
when changing the operation mode to the external air introduction mode, the control device sends out air from the defroster duct.

10. The movable body according to claim 1,
wherein the monitoring device is a camera for monitoring an environment in front of the movable body, and
the window member is a windshield.

11. The movable body according to claim 1,
wherein the movable body is an electric vehicle.
